(19) United States
(12) Patent Application Publication
(10) Pub. No.: US 2026/0294157 A1
(43) Pub. Date: Oct. 1, 2026

(54) METHOD FOR BREWING COFFEE

(71) Applicant: SOCIÉTÉ DES PRODUITS NESTLÉ S.A., Vevey (CH)

(72) Inventors: Gaylord VIKY, Saint-Antoine (FR); Mia DUBEI, Epalinges (CH); Jean-Marc FLICK, Pomy (CH); Jean-Daniel BLUNIER, Estavayer-le-Lac (CH); Yann EPARS, La Conversion (CH)

(21) Appl. No.: 19/479,878

(22) PCT Filed: May 1, 2024
(86) PCT No.: PCT/EP2024/061982

§ 371 Date: Oct. 29, 2025

(30) Foreign Application Priority Data
May 1, 2023 (EP) 23170896.7

(51) Int. Cl. A47J 31/00; A47J 31/06; A47J 31/36

(52) U.S. Cl. CPC A47J 31/002; A47J 31/0652; A47J 31/3614; A47J 31/3619

(57) ABSTRACT

The invention concerns a method to prepare de filter coffee with a full automatic coffee machine (100) comprising: —a brewing chamber (1), an upper piston (2), a lower piston (3) movable inside said brewing chamber (1), wherein the brewing chamber and/or the upper piston are relatively movable between at least two different first and second closed positions configured for brewing roasted and ground coffee powder, wherein the first closed position is configured for compacting coffee during brewing and the second closed position defines the largest possible closed volume of the brewing chamber, —a water fluid system comprising at least a water supply (101) and a water pump (102) wherein said system is connected to the water inlet (13) of the coffee extraction unit, wherein the method comprises the steps of:-moving the chamber (1) and the upper piston (2) relatively one to the other to the second closed position defining the largest possible closed volume of the brewing chamber, then-supplying pumped water in pulses.

### FIELD OF THE INVENTION

The present invention relates to an apparatus for preparing coffee beverages. In particular, it relates to a fully automatic coffee apparatus.

### BACKGROUND OF THE INVENTION

Full automatic coffee machines are configured to prepare coffee in an automatic manner, and first and foremost, to prepare pressurized coffees like espresso, ristretto, Lungo, Americano, . . . .

For that reason, generally, in full automatic coffee machines, a pressurized coffee is prepared in a brewing chamber configured to receive a quantity of roasted and ground (R & G) coffee powder, to compress said quantity of coffee by means of at least one movable piston and to introduce pressurized water through the compressed coffee powder to extract coffee. Finally, the extracted coffee beverage flows out from an outlet of the brewing chamber into a drinking cup.

Coffee consumers request more and more varieties and would like to drink other types of coffees than pressurized coffees, in particular the so-called drip or filtered coffee which is a coffee prepared by pouring hot water onto R & G coffee powder that is retained in a filter. This type of coffee does not comprise any crema, its taste is smooth and balanced and often it is prepared in a large volume producing a long cup or even a carafe. It can be prepared and drunk at cold or ambient temperature too. There is a need for full automatic machines able to prepare pressurized coffees and coffees similar to filter coffees.

Different solutions exist to answer this need.

Some full automatic coffee machines provide an external accessory like a coffee jug (EP3669715) or a specific coffee chamber (DE102018125703) configured to hold R & G coffee powder and pass hot water dispensed from the machine through said accessory and coffee powder. Yet the handling of this accessory is cumbersome for the operator: the accessory must be filled with coffee powder manually, the accessory attached manually to the water dispensing outlet of the machines and at the end, the extracted coffee must be removed and the accessory cleaned manually.

Other full automatic machines enables the preparation of either pressurized coffee or so-called filter coffee through the control of the movement of the piston in the chamber of full automatic machine.

JP2002183827 proposes to control of the movement of the piston so as to extract coffee with the coffee powder not compressed when filter coffee is selected, while the piston is controlled to be moved to compress the coffee powder when pressurized coffee is selected. US2014150664, WO2014119414 and EP3253263 disclose a similar method.

Within these prior arts, no interest is provided for the importance of adjusting the pressure of water to the type of coffee prepared in the brewing chamber. It appears that the pressure used for the preparation of the filter coffee is more a consequence of the size of the chamber set by the position of the piston rather than the selection of a specific pressure of water to be introduced inside the chamber.

As a result, the preparation of the filter coffee is not optimised.

In order to adapt the pressure, one solution is to provide hot pressurised water from an adjustable flow pump controlled to provide water at different pressures like in EP1267685 or to provide the brewing chamber with two different coffee beverage outlets configured for opening at different pressure thresholds like in US2014150664. Yet such embodiments are complex and expensive.

An object of the invention is to address the above existing problems.

### SUMMARY OF THE INVENTION

In a first aspect of the invention, there is provided a method to prepare a filter coffee with a full automatic coffee machine, this machine comprising a coffee extraction unit, said coffee extraction unit comprising:
a brewing chamber for receiving roasted and ground coffee powder, said chamber comprising an upper rim and a bottom wall, and
an upper piston, said upper piston being configured to be movable through the upper rim of the brewing chamber and inside the brewing chamber further to the relative movement of the brewing chamber and the upper piston, and
a water inlet,
a liquid outlet duct guiding extracted coffee beverage to a dispensing area,
a lower piston movable inside said brewing chamber between:
   a lowest position wherein the lower piston lies at the bottom of the brewing chamber, and
   a highest position wherein the lower piston is at the upper rim of the brewing chamber,
a discharge device for spent coffee,
wherein the brewing chamber and/or the upper piston are relatively movable between:
   an open position for introducing roasted and ground coffee powder or ejecting extracted roasted and ground coffee powder, where the upper piston is at a distance from the upper rim of the chamber and outside the chamber, and
   different closed positions configured for brewing roasted and ground coffee powder,
a water fluid system comprising at least a water supply, a water pump, and preferably a water heating device, wherein said system is connected to the water inlet of the coffee extraction unit, wherein the method comprises the steps of:
a—obtaining beverage selection input for a filter coffee from the user about the type of preparation of the coffee in the list of at least a pressurized coffee and a filter coffee, then
b—in the open position of the brewing chamber and the upper piston, supplying a dose of roasted and ground coffee powder in the chamber, said roasted and ground coffee powder, then
c—moving the chamber and the upper piston relatively one to the other to one closed position without compacting the supplied dose of roasted and ground coffee powder, preferably to a closed position defining the largest possible closed volume of the brewing chamber, then
d—supplying pumped water through the water inlet to the brewing chamber and dispensing extracted coffee beverage through the liquid outlet duct, then
e—compacting extracted coffee powder inside the chamber, then
f—discharging the extracted coffee powder from the chamber,
wherein all along step d), pumped water is continuously supplied in pulses.

The coffee extraction unit comprises a brewing chamber that is designed and oriented along a longitudinal axis. This axis can be oriented substantially vertically or inclined relatively to vertical or even oriented substantially horizontally.

The brewing chamber defines an internal volume configured for receiving a dose of roasted and ground coffee powder to be extracted. Usually, the chamber presents a cylindrical shape with a lateral wall extending from a bottom wall up to an upper rim. The longitudinal axis of the cylindrical shape is preferably oriented substantially vertically.

The top of the brewing chamber is opened to enable the introduction of the coffee powder to be extracted.

The extraction unit comprises a water inlet configured to introduce water inside the chamber to extract coffee powder present inside the chamber.

The coffee machine comprises two pistons able to move relatively one to the other through the internal volume of the chamber.

The first piston is able to move through the upper part of the chamber and is called the upper piston. This upper piston is designed to be movable through the upper rim of the brewing chamber and inside the brewing chamber further to the relative movement of the brewing chamber and the upper piston. This upper piston is designed to enable the compression of the coffee powder present inside the chamber and, for this reason, the upper piston is also called compression piston.

The second piston is called the lower piston. The lower piston is movable inside the brewing chamber between two end positions. One end position is the lowest position of the second piston inside the chamber. In this lowest position, the head of the lower piston lies on the bottom wall of the brewing chamber. Generally, the lower piston is positioned in this lower position during the operation of introducing coffee powder inside the chamber and during the operation of extracting coffee powder with water.

The other end position is the highest position of the second piston inside the chamber. In this highest position, the upper surface of the head of the lower piston is at the upper rim of the brewing chamber. Generally, the lower piston is positioned in this highest position during the operation of evacuating the extracted coffee powder from the chamber.

The lower piston comprises a head and a rod.

The lower piston is assembled to the brewing chamber so that its piston rod extends through an opening in the bottom wall of the brewing chamber, the bottom free end of the rod being located outside the chamber. The piston rod is configured to move up and down inside the opening.

The extraction unit comprises a liquid outlet duct. This duct enables the dispensing of extracted coffee from the chamber. Usually, this duct extends from the upper piston to a nozzle for dispensing the beverage in a cup in the dispensing area of the machine.

The coffee extraction unit can be configured to implement a top-down extraction (gravitational extraction) or configured to implement a bottom-up extraction (anti-gravitational extraction).

In the unit configured for bottom-up extraction, water is introduced through the bottom of the chamber and extracted coffee is dispensed through the top of the chamber. Usually, for the bottom-up configuration:
the water inlet is positioned inside the lateral wall of the chamber, preferably close to the bottom wall.
the head of the lower piston presents water openings configured to introduce water from the water inlet upwards and to the coffee powder present inside the chamber,
the upper piston comprises the liquid outlet duct.

In the unit configured for top-down extraction, water is introduced through the top of the chamber and extracted coffee is dispensed through the bottom of the chamber. Usually, for the top-down configuration:
the water inlet is positioned inside the upper piston,
the head of the upper piston presents water openings configured to introduce water from the water inlet downwards and to the coffee powder present inside the chamber,
the lower piston comprises the liquid outlet duct.

The machine comprises a supporting frame on which the brewing chamber is mounted.

The relative movements of the brewing chamber and the two pistons can be implemented indifferently by:
keeping the brewing chamber fixed to the supporting frame and actuating the pistons inside and/or out the chamber, and/or
actuating the brewing chamber relatively to the supporting frame while the pistons remain fixed or are passively driven by the movement of the chamber that holds them.

In one preferred embodiment, the brewing chamber is made movable by driving means. The driving means can be a rack or any other known means.

Within this embodiment, preferably:
the upper piston is fixed,
the rod of the lower piston comprises a free bottom end located outside the brewing chamber and movable with said piston and said chamber,
the apparatus comprises a fixed bottom stop wall able to contact with the bottom end of the rod of the lower piston,
the movement of the lower piston depends on the movement of the brewing chamber and/or the contact of the free bottom end with the bottom stop wall or the contact of the lower piston with the upper piston.

Preferably, in this preferred embodiment, the lower piston is free from guiding means, from retaining means and from springs meaning that the lower piston is passive and there is no active means to change the position of lower piston with respect of the brewing chamber.

Preferably, in this preferred embodiment, the rod and/or the lower piston are provided with friction means to control their movement with respect to the internal walls of the brewing chamber. These means enable the lower piston to be maintained in one position with respect to the brewing chamber.

In an alternative embodiment, the brewing chamber can be mounted fixed in the machine and the upper and lower pistons can be made movable inside and out of the brewing chamber by driving means.

The coffee extraction unit comprises a discharge device for extracted coffee powder (coffee cake). This discharge device is designed to swipe the area above the upper rim of the chamber by any rotation or translation movement when the lower piston is positioned at its highest position.

The full automatic coffee machine comprises a water fluid system comprising at least a water supply and a water pump, and preferably a water heating device. This system is connected to the water inlet of the coffee extraction unit. Accordingly, pressurized water is supplied to the brewing chamber for the extraction of roasted and ground coffee powder. The fluid system can comprise a valve and a conduit to bypass the beating device in order to supply non-heated pumped water, for example for the preparation of a so-called cold brew coffee.

Usually, this full automatic machine is designed for the preparation of pressurised coffee such as espresso. For such a preparation, the brewing chamber and/or the upper piston are relatively movable to a closed position configured for compacting roasted and ground coffee powder introduced in the chamber and brewing compacted coffee. Depending on the quantity and/or the volume of coffee introduced inside the chamber, the brewing chamber and/or the upper piston can be relatively movable to different closed positions enabling coffee compaction.

In addition, it is possible to implement a method to prepare filter coffee with this machine by implementing the following successive steps:
a—obtaining beverage selection input for a filter coffee from the user about the preparation of a filter coffee, then
b—in the open position of the brewing chamber and the upper piston, a dose of roasted and ground coffee powder is supplied in the chamber. This dose of roasted and ground coffee powder, that freely falls in the chamber, represent a volume inferior to the largest possible closed volume of the brewing chamber. It means that there is no risk that the supplied coffee powder is going to be compacted in the chamber during the following step.
c—the chamber and the upper piston are moved relatively one to the other to a closed position without compacting the supplied dose of roasted and ground coffee powder. Preferably this closed position defines the largest possible closed volume of the brewing chamber, so that the combination of steps b) and c) guarantees that there is no risk that the supplied coffee powder is compacted in the chamber at the end of step c).
d—pumped water is supplied through the water inlet in the chamber and all along this step d), pumped water is continuously supplied in pulses. As water is supplied in the chamber, it fills the chamber, contacts and extracts the coffee powder and the resulting extracted beverage is dispensed through the beverage outlet.
e—at the end of the preparation, extracted coffee powder is compacted inside the chamber.
f—finally the extracted coffee powder is discharged from the chamber.

By simultaneously:
extracting a quantity of roasted and ground coffee that represents a volume inferior to the internal volume of the closed chamber defined for the extraction, and
supplying continuously pumped water in pulses all along the extraction in the brewing chamber,
it is possible for water to gently contact and agitate coffee particles inside the chamber, which creates a short contact time between coffee and water and provides a final extraction yield similar to a coffee obtained by the usual filtering process (in which, roasted and ground coffee powder is placed in a paper filter hold in a funnel and water is manually gently poured on the coffee powder with extracted coffee collected in a receptable placed below).

In the present invention, supplying continuously pumped water in pulses means actuating the water pump alternatively on and off during short periods inferior to few seconds, preferably inferior to 1 second.

Generally, the frequency and the length of the pulses are set so as to prevent pressure inside the brewing chamber to rise above 3 bars. That enables a low pressure extraction for the coffee filter preparation.

Generally, in step d), the quantity of pumped water is larger than the internal volume of the closed chamber.

As a result, water is not able to remain in contact with coffee powder a long time. Extracted coffee beverage is pushed out of the brewing chamber through the liquid outlet as long as water is pumped.

Preferably, in step e), the chamber and the upper piston are moved relatively one to the other to compact extracted coffee powder in the chamber, the speed of said movement being inferior to 45 mm/sec, preferably inferior to 30 mm/sec and then the chamber and the upper piston are moved away one from the other and these movements are repeated at least once, preferably twice.

These preferred steps e) enable the dispensing of liquid remaining in the chamber once the pump has stopped and the compaction of swelled coffee powder which presents a mud-like aspect at the end of the extraction.

By controlling the relative movement of the piston and the chamber, extracted liquid can be dispensed through the liquid outlet without splashing effect in the final dispensing nozzle.

In one particular embodiment, steps d) and e) can overlap. In that embodiment, pumped water is still supplied while the chamber and the upper piston are moved relatively one to the other to compact extracted coffee powder in the chamber. This operation enables a decrease of the global time of preparation of the coffee and its dispensing.

Preferably, the machine comprises a bypass valve upstream the water inlet to dispense water to the beverage dispensing area of the machine. Usually, such water is dispensed through a nozzle positioned in the beverage dispensing area above the drinking cup. Accordingly, it is possible to dilute the coffee dispensed in the drinking cup like an americano coffee type.

Preferably, this step is dilution is implemented simultaneously to the step e) of compaction in order to optimise the time of the preparation.

Generally, the machine comprises a water heating device to supply the chamber with hot water for the preparation of a hot filter coffee.

The machine can also be configured to supply the chamber with ambient water for the preparation of a so-called cold brew coffee. The preparation is similar to the preparation of filter coffee except that the temperature of the beverage is lower and, for this reason, the extraction yield of the beverage is lower. Ambient water can be supplied by switching off the water heating device during the pumping operation of water.

Accordingly, it is possible to extract coffee powder with water presenting a low (ambient) temperature and to prepare a so-called cold brew coffee.

Generally, in step f), the chamber, the upper piston and the lower piston are moved relatively one to the other in order to:
position the upper rim of the chamber away from the upper piston, and
position the lower piston at the upper rim of the brewing chamber, and
discharging the extracted coffee powder from the lower piston.

Generally, in step b), roasted and ground coffee powder presenting a coarse particle size is introduced in the brewing chamber. Preferably the powder presents a particle size diameter D4,3 comprised between 450 and 550 μm.

Generally, the full automatic coffee machine comprises a control system configured to:
actuate the movement of the brewing chamber and/or the pistons,
control the devices of the water fluid system, that is at least the water pump and optionally the water heating device and/or the actuator of the bypass valve.

In particular, the control system is configured to make the brewing chamber and/or the upper piston relatively movable one to the other between:
an open position for introducing roasted and ground coffee powder or ejecting extracted roasted and ground coffee powder, and
at least two different first and second closed positions configured for brewing roasted and ground coffee powder.

In the first closed position of the brewing chamber and the upper piston, coffee is compacted during brewing, which enables the preparation of a pressurized coffee.

On the contrary, in the second closed position of the brewing chamber and the upper piston, coffee is not compacted during brewing, which enables the preparation of a filter coffee. Coffee powder remains loose inside the brewing chamber during the extraction. Preferably, this second closed position of the brewing chamber defines the largest possible closed volume of the brewing chamber.

In addition, the control system is configured to supply pumped water:
either as a continuous pressurized flow enabling the preparation of a pressurized coffee inside a compacted layer of roast and ground coffee like espresso at a pressure above 8 bars, preferably between 9 and 10 bars,
or in pulses for the preparation of a filter coffee from non-compacted roast and ground coffee hold inside a large chamber at a pressure below 3 bars, preferably below 2 bars. The pump is preferably a solenoid pump that is:
actuated continuously at 100% of its power all along the preparation of a pressurized coffee,
switched on and off to create pulses all along the preparation of a coffee filter.

Consequently, the machine enables the optimal preparation of a pressurized coffee or a filter coffee because the critical parameters of pressure and compression are met for each type of preparation.

Preferably, the machine comprises one single tank for storing coffee beans and one grinder for grinding stored coffee beans and for dispensing roast and ground coffee in the brewing chamber.

In the present application the terms “filter coffee” are used to define a coffee beverage obtained at low pressure extraction (meaning inferior to 2 bars) and at a cold or hot temperature.

In the present application the terms “internal”, “top”, “bottom” and “lateral” are used to describe the relational positioning of features of the invention. These terms should be understood to refer to the devices in their normal orientation when positioned in a full automatic coffee apparatus for the production of a beverage as shown in the figures.

In the present application the terms “particle size diameter D4,3” represents the mean volumetric diameter of the powder and corresponds to the diameter at the position of the centre of gravity of the particle size distribution. The particle size distribution is measured under dry conditions using a laser diffraction instrument Malvern® Mastersizer 2000, software version 5.60. For dispersing the samples, a dispersion unit, Sirocco is used at air pressure of 2 bar. The conditions follow the recommendations of ISO 13320-1.

In the present invention, “filter coffee” means a coffee beverage prepared by extraction of roast and ground coffee under a pressure inferior to 3 bars.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### DETAILED DESCRIPTION OF EXEMPLARY EMBODIMENTS

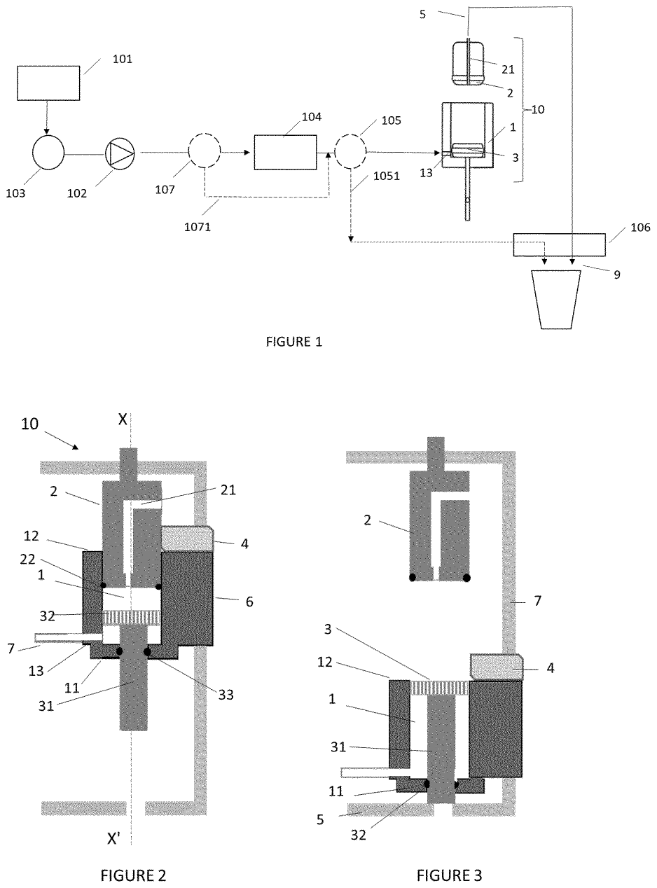

FIG. 1 is a schematic view of a full automatic coffee machine comprising a bottom-up extraction chamber,

FIGS. 2 and 3 illustrate schematically the coffee extraction unit of the full automatic coffee machine of FIG. 1 in two different operating steps,

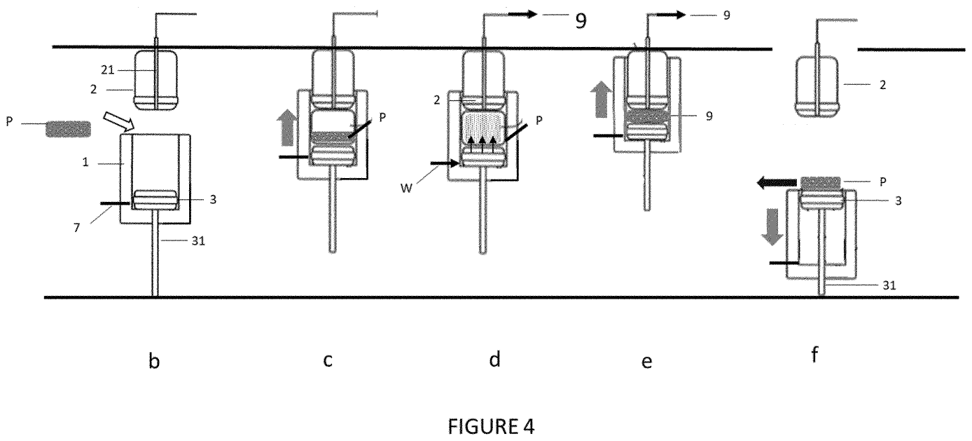

FIG. 4 illustrates the steps of preparation of a filter coffee with the full automatic coffee machine of FIG. 1,

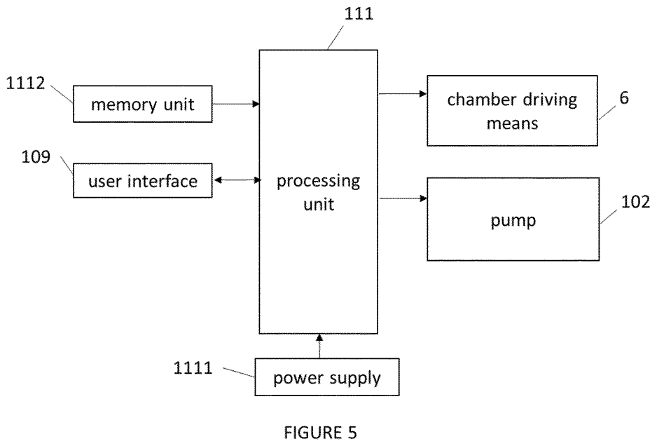

FIG. 5 is a schematic illustration of the control system of the full automatic coffee machine of FIG. 1.

The full automatic coffee machine comprises a water fluid system such as illustrated schematically in FIG. 1.

The line of the system comprises successively:
a water tank 101,
a pump 102
a heater 104, preferably an on-demand or instant heater which provides the advantage of enabling the delivery of ambient water when this heater is switched off.

The end of this hot water fluid line is connected to the water inlet 13 of the brewing chamber part of the coffee extraction unit 10.

Preferably, the fluid system can comprise a flowmeter 103 for a better control of the preparation.

In one particular embodiment, the fluid system can comprise a bypass valve 105 (illustrated in dotted line) to enable the dispensing of pumped water through the line 1051 to another point of delivery, in particular at the dispensing area 106 of the coffee drink to dilute coffee dispensed from the extraction unit. In such a preparation, water is added directly inside the cup of coffee that was dispensed from the brewing chamber.

For a cold or ambient preparation, it is possible to introduce water in the chamber by switching off the heater and pumping water from the tank. In that case, a cold brew coffee like is obtained.

FIGS. 2 and 3 illustrates schematically the coffee extraction unit 10 of the full automatic coffee machine of FIG. 1.

In FIG. 2, the coffee extraction unit 10 is represented in a step of coffee extraction of the chamber, whereas in FIG. 3, the coffee extraction unit 10 is represented in a step of evacuation of coffee cake at the end of the sequence of operations for the preparation of a coffee beverage.

The coffee extraction unit 10 comprises a brewing chamber 1 for receiving a dose of coffee powder, usually roasted and ground coffee. Preferably, the brewing chamber 1 is a cylinder with an open top extending from a bottom wall 11 to un upper rim along an axis XX′ substantially vertical. The chamber 1 comprises a water inlet 13 to which the water fluid supply is connected. The water inlet 13 is preferably positioned close to the bottom of the chamber such as inside the lower part of the lateral wall as illustrated in FIG. 2 or optionally in the bottom wall.

The coffee extraction unit 10 comprises driving means 6 to move vertically the chamber 1 up and down. For example, the chamber 1 can be mounted on a worm drive by motor means. Rotation of the worm causes vertical translation of the chamber.

The coffee extraction unit 10 comprises an upper piston 2. This upper piston 2 presents a lower end portion presenting a cylindrical design and having a diameter substantially equal to the diameter of the chamber so that the upper piston is able to pass through the upper rim 12 of the chamber and inside the brewing chamber further to the movement of the brewing chamber upwardly in direction of the upper piston. Accordingly, the upper piston enables the closure of the brewing chamber during the coffee extraction (FIG. 2) and the compression of a dose of roasted and ground coffee powder introduced inside the brewing chamber is required, which is the case for the usual preparation of a pressurized coffee like espresso. Coffee powder can be introduced inside the chamber by means of a chute (not illustrated) guiding the dose of power in direction of the open top of the chamber.

In addition, the upper piston 2 comprises a liquid outlet duct 21 extending from the bottom surface of the upper piston and connected to a coffee beverage dispensing line.

The coffee extraction unit 10 comprises a lower piston with a head 32. In the preferred illustrated embodiment, this head comprises water outlets 34 configured for distributing water introduced through the water inlet 11 in the bottom surface of coffee positioned above the head of the lower piston (FIG. 2). This head acts as water supplier. A water distributor (not illustrated) is positioned above to distribute water through the coffee powder.

The head is disc-shaped and has a diameter substantially equal to the inner diameter of the chamber cylinder. The lower piston 3 comprises a rod 31 fixed to the bottom of the disc-shaped head 32 and that extends downwards. The piston 3 is assembled to the chamber with the rod 31 extending through an opening in the bottom wall of the chamber.

The rod 31 of the lower piston is free from guiding means, retaining means spring wherein the lower piston is co-axially movable with the brewing chamber and within said brewing chamber.

Usually a mesh filter (not illustrated) is placed at the upper surface of the head of the lower piston to retain coffee particles.

The lower piston 3 is movable inside the brewing chamber 1 between two end positions:
a lowest position wherein the lower piston lies on the bottom wall 11 of the brewing chamber (FIG. 2) and
a higher position wherein the lower piston is at the upper rim 12 of the brewing chamber (FIG. 3).

The coffee extraction unit 10 comprises a discharge device 4 to sweep away a coffee cake that has been extracted (FIG. 3). It is positioned slightly above the upper rim of the brewing chamber. Coffee cake that has been swept away is stored in a cake receiving section.

In the present illustrated embodiment, the upper piston 2 is fixed. The lower piston 3 is co-axially movable:
with the brewing chamber 1, which means that when the chamber 1 moves, it takes the lower piston simultaneously with it, and
within the brewing chamber 1, which means that the lower piston can be moved at different positions inside the brewing chamber. The movement of the lower piston 3 inside the brewing chamber is driven by the contact of the disc-shaped member 32 of the piston rod against the upper piston 2 when the brewing chamber moves upwards and by the contact of the bottom end 312 of the piston rod of the lower piston against a bottom stop wall 5 when the brewing chamber moves downwards. When the lower piston 3 is stopped in its course upwardly by the upper piston 2, the continuous upwards movement of the chamber enables the relative movement of the piston 3 inside the chamber, the same happens with the bottom stop wall during the downwards movement of the chamber.

Any other mechanism from the state of the art enabling the relative movements of the chamber and the upper and lower pistons can be used, in particular when a top-down extraction is implemented.

This full automatic coffee machine comprises a user interface (not illustrated) to enable the selection of the type of coffee, in particular the choice of filter coffee or pressurized coffee preparation.

The hardware of the user interface may comprise any suitable device(s), for example, the hardware comprises one or more of the following: buttons, such as a joystick button, knob or press button, joystick, LEDs, graphic or character LDCs, graphical screen with touch sensing and/or screen edge buttons.

A part of the user interface can also be on a mobile app when the full automatic coffee machine is provided with a communication interface as described below. In that case, at least a part of input and output can be transmitted to the mobile device through the communication interface.

Preferably, the full automatic comprises a tank to store roasted coffee beans and a coffee beans grinder so that a dose of roasted and ground coffee can be dispensed from the grinder outlet inside the brewing chamber 1.

This full automatic coffee machine enables the preparation of pressurized coffee as well known in the state of the art by implementing the following steps:
a—in a dosing position, where the upper piston 2 is at a distance from the upper rim 12 of the chamber and outside the chamber, supplying a dose of roasted and ground coffee powder corresponding to a pressurized coffee preparation into the brewing chamber, then
b—moving the chamber 1 and the upper piston 2 relatively one to the other to a first position where:
   the chamber upper opening is closed, and
   the dose of coffee powder is compressed between the lower piston 3 and the upper piston 2, then
c—introducing hot water inside the chamber, extracting the coffee powder and dispensing extracted coffee through the beverage outlet 21 of the upper piston and then through the coffee dispensing nozzle 9 inside a cup, then
e—discharging the extracted coffee powder from the chamber by moving the chamber 1 away from the upper piston 2 so that the lower piston is moved upwardly inside the chamber up to the upper rim 12. At this position, the coffee cake can be swiped by the discharge device 4 and collected in the waste collector.

This full automatic coffee machine enables the preparation of filter coffee too as illustrated in FIG. 4 by implementing the following steps:
b—in a dosing position, where the upper piston 2 is at a distance from the upper rim 12 of the chamber and outside the chamber, supplying a dose of roasted and ground coffee powder 9 corresponding to a filter coffee preparation into the brewing chamber, then
c—moving the chamber 1 and the upper piston 2 relatively one to the other to a second position where the chamber upper opening is closed. Yet, the dose of coffee powder P is not compressed between the lower piston 3 and the upper piston 2. As a result, the coffee powder will be kept loose during the beverage preparation, which is a key condition for the preparation of filter coffee. Preferably, the chamber 1 and the upper piston 2 are positioned one relatively to the other in order to provide the broadest internal volume while keeping the chamber closed.
d—introducing hot water W inside the chamber (FIG. 3C) with the effect of extracting the coffee powder. As water fills the chamber volume, extracted coffee filter is dispensed through the beverage outlet 21 of the upper piston and then through the coffee dispensing nozzle 9 inside a cup.

At the end of the introduction of water, a certain volume of liquid remains inside the chamber since coffee powder was not compressed during the extraction. This extracted coffee and remaining liquid forms a sort of mud. The chamber must be thoroughly cleaned before a new coffee is prepared. Then, at least the following steps are implemented.
e—moving the chamber 1 and the upper piston 2 relatively one to the other to tamp the extracted coffee powder present in the chamber. During said operation, the liquid still present in the chamber is evacuated through the outlet duct 21 of the upper piston and dispensed through the coffee nozzle 9 inside the drinking cup and forms part of the filter coffee beverage. In that case, the final beverage can comprise some small solid residues which remains acceptable for this type of coffee.

The position of the chamber to obtain the tamping effect can be determined by the measure of the electric current supplied to the motor that actuates the chamber and by stopping the movement of the chamber when a preset threshold of the current is reached. Any alternative known manner to detect the tamping position can be used.

Preferably, this tamping is repeated at least once, preferably at least twice, by moving the chamber 1 away from the upper piston 2 and then moving them relatively one to the other to tamp the coffee powder. In this second tamping operation, the chamber can be moved only slightly away from the upper piston, e.g. by 2 or 5 mm; there is no need to move the chamber to its broadest internal volume.

Several tamping operations enables a complete drying of the coffee powder. Improving drying guarantees a better cleaning of the chamber with less residues remaining in the chamber and a better swiping of the coffee cake 7 by the discharge device 4.

Depending on the type of coffee powder used, the coffee powder can present different hygroscopic properties that directly affect the facility to dry the wetted powder. This property can depend on the level of roasting, the nature of the coffee beans (arabica, robusta, . . . ), the grind size. Accordingly, the number of tamping operations can be adapted to the used coffee powder.
f—discharging the extracted coffee powder from the chamber by moving the chamber 1 away from the upper piston 2 so that the lower piston is moved upwardly inside the chamber up to the upper rim 12. At this position, the coffee cake can be swiped by the discharge device 4 and collected in a waste collector.

FIG. 5 is a schematic illustration of the control system of the full automatic coffee machine comprising the fluid system of FIG. 4.

The control system typically comprises: a processing unit 111, a power supply 1111, a memory unit 1112.

The processing unit 111 generally comprises memory, input and output system components arranged as an integrated circuit, typically as a microprocessor or a microcontroller. The power supply 1111 is operable to supply electrical energy to the said controlled components and the processing unit.

The processing unit 111 generally comprises a memory unit 1112 for storage of instructions as program code and optionally data.

The instructions stored on the memory unit 112 can be idealised as comprising a program to adjust the internal volume of the chamber 1 according to the type of coffee to be prepared based on the input provided by the user interface 109.

During a coffee beverage preparation, the control system is operable:
to obtain the beverage selection input from the user about the type of preparation of the coffee in the list of: pressurized coffee and filter coffee
to actuate the driving means of the chamber to move the brewing chamber and/or the upper piston to the first closed position for a pressurized coffee input or to the second position for a filter coffee preparation, and
to actuate the pump 102 in a normal mode for a pressurized coffee input or in a pulse mode for a filter coffee.

Coffees were prepared with the illustrated full automatic machine presenting the following characteristics:
internal volume of the chamber: 45 ml
pump is a solenoid pump.

To prepare an espresso coffee:
9 g of roasted and ground coffee with a particle size diameter D4,3 comprised between 330 and 360 μm are introduced in the chamber, and
the upper piston is moved to a first closed position and compact this dose of coffee inside the chamber,
40 ml of hot water (92° C.) is supplied in the chamber with the pump powered at 100%.

To prepare a filter coffee:
12 g of roasted and ground coffee with a particle size diameter D4,3 comprised between 450 and 550 μm are introduced in the chamber, and
the upper piston is moved a second closed position that defines the largest possible closed volume of the brewing chamber. Powder coffee is not compacted.
the pump is used to deliver 200 ml of water in pulses by switching on the pump for 0.3 sec at 100% of its power and then off during 0.1 sec alternatively during 40 to 45 sec.
then the upper piston is slowly moved to a closed position to press coffee mud at the bottom of the chamber. The speed of movement of the upper piston is inferior to the speed of movement of the upper piston applied to compact roast and ground coffee powder during the espresso preparation.

Although the present invention was illustrated with a full automatic coffee machine comprising an extraction unit based on a bottom-up extraction, the same method of preparation applies in an extraction unit based on a top-down extraction.

The present invention enables the preparation of a filter coffee with a full automatic coffee machine configured to prepare pressurized coffee, like espresso, by means of a pump device designed to dispense pumped water at a pressure above 9 bars.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

List of references in the drawings:

| | |
|---|---|
| coffee extraction unit | 10 |
| brewing chamber | 1 |
| bottom | 11 |
| upper rim | 12 |
| water inlet | 13 |
| upper piston | 2 |
| outlet duct | 21 |
| lower piston | 3 |
| piston rod | 31 |
| head | 32 |
| discharge device | 4 |
| outlet tube | 5 |
| chamber driving means | 6 |
| carrier | 7 |
| dispensing nozzle | 9 |
| water tank | 101 |
| pump | 102 |
| flow meter | 103 |
| heater | 104 |
| bypass valve | 105 |
| americano water line | 1051 |
| dispensing area | 106 |
| user interface | 109 |
| processing unit | 111 |
| power supply | 1111 |
| memory unit | 1112 |
| water | W |
| roasted and ground coffee powder | P |

1. A method to prepare a filter coffee with a full automatic coffee machine, the machine comprising a coffee extraction unit, the coffee extraction unit comprising:
a brewing chamber for receiving roasted and ground coffee powder, the brewing chamber comprising an upper rim and a bottom wall,
an upper piston configured to be movable through the upper rim of the brewing chamber and inside the brewing chamber further to the relative movement of the brewing chamber and the upper piston,
a water inlet,
a liquid outlet duct guiding extracted coffee beverage to a dispensing area,
a lower piston movable inside the brewing chamber between:
a lowest position wherein the lower piston lies at the bottom of the brewing chamber, and
a highest position wherein the lower piston is at the upper rim of the brewing chamber,
a discharge device for spent coffee,
wherein the brewing chamber and/or the upper piston are relatively movable between:
an open position for introducing the roasted and ground coffee powder or ejecting extracted roasted and ground coffee powder, where the upper piston is at a distance from the upper rim of the chamber and outside the chamber, and
different closed positions configured for brewing the roasted and ground coffee powder, and
a water fluid system comprising at least a water supply, and a water pump, wherein the water fluid system is connected to the water inlet of the coffee extraction unit,
wherein the method comprises the steps of:
a—obtaining beverage selection input for the filter coffee from a user about a type of preparation of the filter coffee in the list of at least a pressurized coffee and the filter coffee, then
b—in the open position of the brewing chamber and the upper piston, supplying a dose of the roasted and ground coffee powder in the brewing chamber, the dose of the roasted and ground coffee powder defining a volume inferior to the largest possible closed volume of the brewing chamber, then
c—moving the brewing chamber and the upper piston relatively one to the other to one closed position without compacting the dose of the roasted and ground coffee powder, then
d—supplying pumped water through the water inlet, extracting the roasted and ground coffee powder and dispensing the extracted coffee beverage through the liquid outlet duct, then
e—compacting the extracted roasted and ground coffee powder inside the brewing chamber, then
f—discharging the extracted roasted and ground coffee powder from the brewing chamber,
wherein all along step d), the pumped water is continuously supplied in pulses.

2. The method according to claim 1, wherein in step d), the quantity of the pumped water is larger than the internal volume of the brewing chamber in the closed position.

3. The method according to claim 1, wherein in step e), the brewing chamber and the upper piston are moved relatively one to the other at a speed inferior to 45 mm/sec to compact the extracted roast and ground coffee powder in the brewing chamber, and then the brewing chamber and the upper piston are moved relatively away one from the other to the closed position defining the largest possible closed volume of the brewing chamber or to an intermediate position,
and these movements are repeated at least once.

4. The method according to claim 1, wherein steps d) and e) overlap.

5. The method according to claim 1, wherein the machine comprises a bypass valve upstream the water inlet to dispense water to the beverage dispensing area of the machine.

6. The method according to claim 1, wherein in step b), the roasted and ground coffee powder has a coarse particle side.

7. A full automatic coffee machine comprising a coffee extraction unit, the coffee extraction unit comprising:
a brewing chamber for receiving roasted and ground coffee powder, the brewing chamber comprising an upper rim and a bottom wall,
an upper piston configured to be movable through the upper rim of the brewing chamber and inside the brewing chamber further to the relative movement of the brewing chamber and the upper piston,
a water inlet,
a liquid outlet duct,
a lower piston movable inside the brewing chamber between:
a lowest position wherein the lower piston lies at the bottom of the brewing chamber, and
a highest position wherein the lower piston is at the upper rim of the brewing chamber,
a discharge device for spent coffee,
wherein the brewing chamber and/or the upper piston are relatively movable between:
an open position for introducing the roasted and ground coffee powder or ejecting extracted roasted and ground coffee powder, and
different closed positions configured for brewing the roasted and ground coffee powder,
a water fluid system comprising at least a water supply, and a water pump, wherein the water fluid system is connected to the water inlet of the coffee extraction unit, and
a control system operable to perform the method of claim 1.

8. The full automatic coffee machine according to claim 7, wherein:
the brewing chamber comprises the water inlet, and
the upper piston comprises the liquid outlet duct.

9. The full automatic coffee machine according to claim 7, wherein the machine comprises one tank for storing coffee beans and one grinder for grinding stored coffee beans and for dispensing roast and ground coffee in the brewing chamber.

10. (canceled)

11. A computer readable storage medium having stored thereon a computer program comprising instructions to cause a full automatic coffee machine to perform the method of claim 1.

12. The method of claim 1, wherein the water fluid system further comprising a water heating device.

13. The method of claim 1, wherein the closed position of the brewing chamber and the upper piston in step c) defines the largest possible closed volume of the brewing chamber.

14. The method of claim 3, wherein speed at which the brewing chamber and the upper piston are moved relatively one to the other to compact the extracted roast and ground coffee powder in the brewing chamber in step e) is inferior to 30 mm/sec.

15. The method according to claim 1, wherein in step b), the roasted and ground coffee powder has a particle size diameter D4,3 between 450 and 550 μm.
